(19) United States
(12) Patent Application Publication
(10) Pub. No.: US 2025/0109328 A1
(43) Pub. Date: Apr. 3, 2025

(54) MULTIFUNCTIONAL MATERIALS FOR COMBINED ELECTROCHEMICAL AND THERMAL ENERGY STORAGE

(71) Applicant: UT-Battelle, LLC, Oak Ridge, TN (US)

(72) Inventors: Jagjit Nanda, Oak Ridge, TN (US); Kashif Nawaz, Oak Ridge, TN (US); Robert L. Sacci, Oak Ridge, TN (US); Andrew Ullman, Oak Ridge, TN (US); Jamieson Brechtl, Oak Ridge, TN (US)

(21) Appl. No.: 18/899,293

(22) Filed: Sep. 27, 2024

Related U.S. Application Data
(60) Provisional application No. 63/541,723, filed on Sep. 29, 2023.

(51) Int. Cl. C09K 5/06; H01M 10/659; H01M 50/429; H01M 50/431; H01M 50/446

(52) U.S. Cl. CPC C09K 5/063; H01M 10/659; H01M 50/429; H01M 50/431; H01M 50/446

(57) ABSTRACT

A phase change material composition for combined electrochemical and thermal energy storage is provided. The composition includes a salt hydrate, a polymeric stabilizer, a nucleating agent, and a thiosulfate salt hydrate. The salt hydrate is present in the composition in an amount of from 0.1 to 99 wt. %. The polymeric stabilizer is present in the composition in an amount of from 0.1 to 20 wt. %. The nucleating agent is present in the composition in an amount of from 0.1 to 20 wt. %. The thiosulfate salt hydrate is present in the composition in an amount of from 0.1 to 25 wt. %. A combined electrochemical and thermal storage system including the phase change material composition is further provided.

### CROSS-REFERENCE TO RELATED APPLICATIONS

This application claims the benefit of U.S. Provisional Application 63/541,723, filed Sep. 29, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF THE INVENTION

The present invention relates to a multifunctional phase change material composition and associated combined electrochemical and thermal storage system.

### BACKGROUND OF THE INVENTION

In 2022 the United States Energy Information Administration indicated that residential and commercial buildings account for ˜39 quads of the total U.S. energy demand. Approximately 40% of this electrical energy is used to power heating, ventilation, and air conditioning (HVAC) systems that modulate air temperatures and humidity levels to deliver excellent comfort to building occupants. HVAC systems are heavily used during peak power demand times, which can contribute to strain on the electrical grid. Energy storage can reduce stress on the electrical grid by increasing flexibility in either thermal or electrical energy storage. For thermal energy storage, one of the most promising approaches for building applications is the use of phase change materials (PCMs), which store or release latent heat upon phase change.

Phase change materials are utilized in a broad range of applications due to their ability to store and release substantial amounts of energy during phase transitions. Common PCMs include organic materials, inorganic salts, and salt hydrates. Salt hydrates are particularly notable for their high latent heat storage capacity and their ability to operate at moderate temperatures, making them suitable for applications such as building temperature regulation, thermal energy storage systems, and temperature-sensitive packaging.

Salt hydrate-based PCMs generally consist of a salt and water, where the water is chemically bound to the salt in a hydrate form. These materials undergo a phase change from solid to liquid and vice versa at specific temperatures, thereby enabling thermal energy storage. Despite their advantageous properties, salt hydrate PCMs often face challenges related to their crystallization behavior, including issues with crystal growth, supercooling, and the formation of non-uniform crystal structures. These challenges can adversely affect the performance and reliability of the PCM in practical applications.

To address these issues, nucleating agents have been introduced to enhance the crystallization process in salt hydrate PCMs. Nucleating agents are substances that promote the formation of desired crystalline structures, thereby improving the consistency and efficiency of the phase change process. They function by providing nucleation sites or modifying the physical properties of the PCM to encourage uniform crystal formation.

Existing nucleating agents used in PCM formulations include various inorganic salts, acids, and minerals. However, the effectiveness of these nucleating agents can vary based on the specific PCM composition and application requirements. Moreover, conventional nucleating agents may not always provide optimal performance in terms of crystallization kinetics, crystal size distribution, or thermal stability.

### SUMMARY OF THE INVENTION

A PCM composition for combined electrochemical and thermal energy storage is provided. The composition comprises a salt hydrate in an amount of from 0.1 to 80 wt. %. The composition further comprises a polymeric stabilizer in an amount of from 0.1 to 20 wt. %. The composition also comprises a non-electrical conducting nucleating agent in an amount of from 0.1 to 20 wt. %. The composition comprises a thiosulfate salt hydrate in an amount of from 0.1 to 25 wt. %. Each wt. % is based on 100 total parts by weight of the composition.

The salt hydrate may comprise a cation comprising hydrogen, lithium, sodium, potassium, cesium, ammonium, tetraethylammonium or a combination thereof. The salt hydrate may further comprise an anion comprising sulfate, thiosulfate, carbonate, bicarbonate, chloride, fluoride, borate, acetate, acetoacetate, oxalate, formate, phosphate, dihydrogen phosphate, and/or hydrogen phosphate. The salt hydrate may comprise a sodium sulfate decahydrate. The salt hydrate may comprise sodium hydrogen phosphate. The salt hydrate may comprise the sodium sulfate decahydrate and the sodium hydrogen phosphate in a mass ratio of 1:100 to 1:2, alternatively 1:8 to 1:3, or alternatively 1:4.5 to 1:3.5.

The polymeric stabilizer may comprise a polysaccharide selected from the group of a nanocellulose, a sulfonated polysaccharide, a starch, a glycogen, a chitin, and combinations thereof. The polymeric stabilizer comprises sodium alginate, lithium alginate, potassium alginate, ammonium alginate, or a combination thereof.

The nucleating agent may comprise an electrical insulating inorganic salt. The electrical insulating inorganic salt may comprise CaF₂, sodium borate, sodium thiosulphate, sodium hydrogen phosphate, TiO₂, Al₂O₃, ZrO₂, Y₂O₃, HfO₂, GeO₂, Sc₂O₃, CeO₂, MgO, BN, SiO₂, or combinations thereof.

The composition may have an overall ionic conductivity of between 1.0 S/cm and 1.0 mS/cm in a liquid state. The composition may have an overall ionic conductivity of between 10.0 mS/cm and 0.01 mS/cm in a solid state.

A combined electrochemical and thermal storage system that comprises the PCM composition is further provided.

An assembly is further provided. a separator having a separator surface and defining pores. The assembly comprises a phase change material disposed within the pores and comprising a salt or salt mixture in an amount of from 0.1 to 80 wt. %. The phase change material further comprises a polymeric stabilizer in an amount of from 0.1 to 20 wt. %. The phase change material additionally comprises a non-electrical conducting nucleating agent in an amount of from 0.1 to 20 wt. % and a polar protic solvent in the amount of from 10 to 80 wt. %. Each wt. % is based on 100 total parts by weight of the composition. The separator has a porosity between 20 and 80% by volume of the separator.

These and other features of the invention will be more fully understood and appreciated by reference to the description of the embodiments.

### DETAILED DESCRIPTION OF THE CURRENT EMBODIMENTS

As discussed herein, the current embodiments relate to a PCM composition for use in combined electrochemical and thermal energy storage. The composition comprises a salt hydrate in an amount of from 0.1 to 99 wt. %. The composition further includes a polymeric stabilizer in an amount of from 0.1 to 20 wt. %. The composition also includes a nucleating agent in an amount of from 0.1 to 20 wt. %. The composition additionally includes a thiosulfate salt hydrate in an amount of from 0.1 to 25 wt. %. Each wt. % is based on 100 total parts by weight of the composition.

The composition comprises a salt hydrate. A salt hydrate is a crystalline compound that comprises salt and water molecules chemically incorporated into the crystal structure of the salt hydrate. These water molecules, known as “water of crystallization,” are integral to the formation and stability of the salt hydrate lattice. In a salt hydrate, the water is not just physically retained within the crystal structure but is chemically bonded, affecting the salt hydrate's physical properties, such as its solubility, density, and thermal behavior. Non-limiting examples of salt hydrates include copper(II) sulfate pentahydrate (CuSO₄·5H₂O), calcium chloride dihydrate (CaCl₂)₂·H₂O), calcium sulfate dihydrate (CaSO₄·2H₂O), sodium carbonate decahydrate (Na₂CO₃·10₂O), sodium sulfate decahydrate (Na₂SO₄·10H₂O), magnesium sulfate heptahydrate (MgSO₄·7H₂O), iron(III) chloride hexahydrate (FeCl₃·6H₂O), zinc sulfate heptahydrate (ZnSO₄·7H₂O), nickel(II) sulfate hexahydrate (NiSO₄·6H₂O), aluminum sulfate octadecahydrate (Al₂(SO₄)₃·18H₂O), sodium thiosulfate pentahydrate (Na₂S₂O₃·5H₂O), potassium chloride hydrate (KCl·H₂O), barium chloride dihydrate (BaCl₂·2H₂O), cobalt(II) chloride hexahydrate (CoCl₂·6H₂O), lithium chloride hexahydrate (LiCl·6H₂O), strontium nitrate hexahydrate (Sr(NO₃)₂·6H₂O), manganese(II) chloride tetrahydrate (MnCl₂·4H₂O), sodium phosphate monohydrate (Na₃PO₄·H₂O), ammonium iron(III) sulfate dodecahydrate ((NH₄)Fe(SO₄)₂·12H₂O), magnesium chloride hexahydrate (MgCl₂·6H₂O), cadmium sulfate pentahydrate (CdSO₄·5H₂O), potassium sulfate monohydrate (K₂SO₄·H₂O), strontium chloride hexahydrate (SrCl₂·6H₂O), chromium(III) chloride hexahydrate (CrCl₃·6H₂O), lead(II) nitrate dihydrate (Pb(NO₃)₂·2H₂O), and combinations thereof. The salt hydrate is generally present in the composition in an amount of from 0.1 to 99 wt. %, alternatively, 80 to 97 wt. %, alternatively 90 to 97 wt. %, or alternatively 92 to 97 wt. %.

Generally, the salt hydrate comprises, alternatively consists essentially of, or alternatively consists of a sodium salt hydrate. In certain embodiments, the sodium salt hydrate comprises a sodium salt decahydrate. The sodium salt hydrate may comprise a sodium hydrogen phosphate hydrate. In specific embodiments, the sodium salt hydrate comprises both sodium salt decahydrate and sodium hydrogen phosphate hydrate. The salt hydrate may comprise the sodium sulfate decahydrate and the sodium hydrogen phosphate in a weight ratio of 1:100 to 1:2, alternatively 1:8 to 1:3, alternatively 1:4.5 to 1:3.5, or alternatively about 1:4.

The composition comprises a polymeric stabilizer. The polymeric stabilizer is utilized in the composition to enhance the thermal stability and structural integrity of the composition. Non-limiting examples of polymeric stabilizers include agar, alginate, and xanthan gum, which help to maintain the uniform distribution of the PCM within a matrix of the polymeric stabilizer. The matrix of the polymeric stabilizer helps to prevent phase separation and degradation over time. The polymeric stabilizer facilitates the formation of a gel or gel-like network such that the polymeric stabilizer improves mechanical properties of the composition, including flexibility and tensile strength, while minimizing leakage during phase transitions. The stability effects of the polymeric stabilizer are crucial for ensuring the longevity and effectiveness of the composition in various application, especially thermal and/or electrochemical energy storage and temperature regulation systems. In certain embodiments, the polymeric stabilizer comprises a polysaccharide selected from the group of nanocellulose, e.g., a sulfonated polysaccharide, a starch, a glycogen, a chitin, and combinations thereof. In specific embodiments, the polymeric stabilizer comprises sodium alginate. The polymeric stabilizer is generally present in the composition in an amount of from 0.1 to 20 wt. %, alternatively 1 to 10 wt. %, alternatively 2 to 7 wt. %, or alternatively 2 to 3 wt. %.

The composition comprises a nucleating agent. A nucleating agent in PCMs serves to facilitate and control the phase transition process by promoting the formation of nuclei, which are essential for initiating the transition between solid and liquid states. By introducing a nucleating agent, the PCM can achieve a more uniform and predictable phase change, leading to improved thermal performance and stability. These agents come in various forms, including inorganic compounds such as titanium dioxide and calcium carbonate, organic substances such as specific polymers, or hybrid combinations that leverage the benefits of both types. In specific embodiments, the nucleating agent comprises an inorganic salt. The inorganic salt may comprise, alternatively consist essentially of, or alternatively consist of a sodium borate hydrate. Each type of nucleating agent works by providing a surface or chemical environment that encourages the formation of stable nuclei, which in turn influences the size and structure of the crystals formed during the phase transition.

The application of nucleating agents in PCMs is crucial for optimizing their thermal energy storage and temperature regulation capabilities. By enhancing nucleation, these nucleating agents ensure that the PCM phase transitions smoothly and efficiently, improving overall performance and longevity. However, careful consideration must be given to the compatibility of the nucleating agent with the PCM and its concentration, as these factors can significantly affect the material's properties and effectiveness. Properly selected nucleating agents thus play a key role in advancing the functionality and durability of PCMs in various applications. The nucleating agent is generally present in the composition in an amount of from 0.1 to 20 wt. %, alternatively 0.3 to 3 wt. %, or alternatively 2 to 3 wt. %.

The composition further comprises thiosulfate salt hydrate. Thiosulfate salt hydrates are compounds consisting of thiosulfate salts combined with water molecules. The thiosulfate salt hydrate may comprise sodium thiosulfate pentahydrate. The thiosulfate salt hydrate is generally present in the composition in an amount of from 0.1 to 25 wt. %, alternatively 0.2 to 20 wt. %, alternatively 0.3 to 20 wt. %, alternatively 7.5 to 17.5 wt. %, alternatively 10 to 25 wt. %, or alternatively 20 to 30 wt. %.

A combined electrochemical and thermal storage system (“the system”) comprising the PCM is also provided. The combined electrochemical and thermal storage system integrates both battery-based energy storage (electrochemical) and thermal energy storage to enhance efficiency and flexibility in energy management. The system is especially responsive to variable energy demand and can use stored electricity during high-demand periods and release thermal energy for heating or cooling. The use of both thermal and electrochemical storage allows for the optimization of energy use, increases in system efficiency, and reductions in waste. It will be appreciated that the system is especially well suited for use on a grid powered by renewable energy sources (e.g., wind, solar) where energy generation may vary with the time of day and allow for the effective balancing of energy supply and demand.

### EXAMPLES

The present composition is further described in connection with the following examples, which are non-limiting.

Examples 1-5 and Comparative Examples C₁-C₅ were prepared by combining sodium thiosulfate pentahydrate (Na₂S₂O₃·5 H₂O, molecular weight (MW)=248.19 amu, Sigma Aldrich), sodium sulfate decahydrate (Na₂SO₄·10 H₂O MW=322.20 amu, Sigma Aldrich), Na Alginate polymer (NaC₆H₇O₆, MW=216.12 amu, Sigma Aldrich), and sodium borate hydrate (B₄H₂ONa₂O₁₇, Borax, MW=381.40 amu, Sigma Aldrich). The Examples are divided into two sets: Comparative Examples 1-3 shown in Table 1, and Examples 1-5 and Comparative Example 4 shown in Table 2. Comparative Examples 1-3 vary the mass loading of Borax, while Examples 1-5 and Comparative Example 4 vary the relative mass loadings of Na₂SO₄ and NaS₂O₃.

The contents of all of the Examples were weighed in the amounts listed in Tables 1-3 and combined at room temperature in glass vials where they were subsequently mixed. The exemplary compositions were then placed onto a magnetic hotplate set to −65° C. until the exemplary compositions were fully melted. After melting, the solution was mixed using a mechanical mixer to further diffuse the polymer into the PCM matrix.

TABLE 1
Varying Weight Loading of Borax

| Example | Mass Na₂SO₄ (g) | Mass Na Alginate (g) | Mass Borax (g) |
|---|---|---|---|
| C1 | 10.001 | 0.650 | — |
| C2 | 10.000 | 0.650 | 0.050 |
| C3 | 10.000 | 0.651 | 0.101 |

TABLE 2
Varying Weight Loading of sodium sulfate decahydrate

| | Mass | Mass | Mass Na | Mass |
|---|---|---|---|---|
| Example | Na₂SO₄ (g) | NaS₂O₃ (g) | Alginate (g) | Borax (g) |
| C4 | 10.000 | — | 0.251 | 0.251 |
| 1 | 9.950 | 0.051 | 0.250 | 0.251 |
| 2 | 9.899 | 0.101 | 0.250 | 0.250 |
| 3 | 9.500 | 0.500 | 0.249 | 0.249 |
| 4 | 9.001 | 1.000 | 0.250 | 0.249 |
| 5 | 8.001 | 2.000 | 0.250 | 0.249 |

TABLE 3
Varying Weight Loading of Disodium phosphate

| | Mass | Mass | Mass Na | Mass |
|---|---|---|---|---|
| Example | Na₂HPO₄ (g) | Na₂SO₄ (g) | Alginate (g) | Borax (g) |
| C5 | 8.000 | 2.000 | 0.651 | 0.101 |

### Synthesis of NVTP@C Composite Active Material

NH₄VO₃ (1 equivalent, 1.05 g, 9 mmol), Na(OAc)₂·3H₂O (2 equivalents, 3.51 g, 18 mmol), NH₄(H₂PO) (3 equivalents, 3.11 g, 27 mmol), citric acid (1 equivalent, 1.73 g, 9 mmol), and 200 mL of deionized water were combined to give a solution. The solution was disposed in a container disposed within an oil bath and heated to 40° C. and stirred. Ti(OCH(CH₃)₂)₄ (1 equivalent, 1.73 g, 2.82 mL, 9 mmol) in 20 mL of isopropanol was added to the solution. The temperature of the oil bath was raised to 80° C. and the solution was stirred for 18 hours open to air.

The water of the solution was evaporated using a rotary evaporator and the resulting olive-green solid precipitate was collected. The solid precipitate was pressed into a 30 mm diameter pellet using 6 tons of force and sintered in a tube furnace at 350° C. for 3 hours and then at 800° C. for 12 hours to give a black solid (4.1 g). The black solid was ground to a fine powder using a mortar and pestle to give the PCM electrolyte. Working electrodes were provided comprising a stainless steel mesh and an active material comprising Na₂TiV(PO₄)₃, Super C65, and Teflon in a mass ratio of 7:2:1. The active material is applied onto the stainless steel mesh by placing the active material on the mesh and then grinding the active material into the pores of the stainless steel mesh using a ceramic pestle.

### Conductivity and CV Cycling

Samples were placed into a Swagelock-like Tee connector device. Stainless steel rods, acting as current collectors, were placed into the two horizontal sides while the PCM electrolyte was placed in a top entry point. Regarding the conductivity measurements, no active material was used, while the active material was used for the cycling experiments. The thermal cycling was performed to gauge the effects of phase change on the behavior. Samples were subjected to temperatures ranging from 0 to 45° C. for approximately 45 hours. Electrochemical spectroscopy was performed using a Biologic potentiostat.

To facilitate charge transfer to and from the active material during experiments, the stainless steel mesh (with active material) was immersed in a 1 M Na₂SO₄ solution for 30 minutes. After removing the stainless-steel mesh from the solution, the stainless-steel mesh was placed into a coin cell above and below filter paper. The filter paper not only acts as a barrier that prevents the electrodes from contacting each other, but also prevents electrical shorting of the cell. Subsequently 60 μL of the Na₂SO₄ solution was added to the interior of the coin cell to further enhance charge transfer. This experiment was performed to establish a baseline measurement, and therefore no PCM was used. Spacers and a spring were added during assembly to keep the electrodes held firmly in place during the measurement. To assemble the cell, it was placed into a cell press in which 80 psi of pressure was applied for approximately 10 seconds and then removed from the press.

### Phase Change Temperature, Latent Heat, and Supercooling

The phase change temperature, latent heat, and supercooling of the Examples were determined by a differential scanning calorimeter (DSC 2500, TA Instruments). Each sample (10-20 mg) was sealed in a hermetically sealed DSC pan and subjected to a thermal procedure at a ramp rate of 2° C./min between −40 and 80° C. under nitrogen flow (50 mL/min). Melting temperatures and phase change enthalpies were calculated using the heating cycle data. The specific heat capacity of each sample was also measured using the ASTM E1269-11 standard.

### X-Ray Diffraction

X-ray diffraction (XRD) was performed on each Example using a PANalytical Empyrean XRD diffractometer with Cu Kα (λ=1.5406 Å) radiation. The operating voltage and current were 45 kV and 40 mA, respectively. Data for the X-ray diffraction patterns were gathered using a scan rate of 4°/min for scattering angles ranging from 4° to 90°.

### Raman Spectroscopy

Raman experiments were implemented on a confocal Raman spectrometer (Horiba, Xplorer) 405 nm, objective=50×, long distance, grating with 4000 grooves/mm (400 nm), numerical aperture (N.A.=0.50, local power <500 μW). Spectra was taken at room temperature, 70° C., and 90° C. using an inhouse temperature-controlled chamber. Before measurements were preformed, the temperature was allowed to dwell at each set point for at least two hours. Laser spot diameter was estimated to be 1 μm and the accumulation time was 10 s for each measurement. All Raman mappings were analyzed using LabSpec 6.0 and Origin software.

TABLE 4
Heating Energy (Qₘₑₗₜ), Freezing Energy (Q_{freeze}), and Change
in Temperature Loop (ΔTₗₒₒₚ) for Comparative Examples 1-3

| Example | Qₘₑₗₜ (J/g) | Q_{freeze} (J/g) | ΔTₗₒₒₚ (° C.) |
|---|---|---|---|
| C1 | −101 | 38.7 | 1.51 |
| C2 | −87.0 | 44.1 | 0.51 |
| C3 | −101 | 48.3 | 5.09 |

TABLE 5
Heating Energy (Qₘₑₗₜ), Freezing Energy (Q_{freeze}),
Difference Between Melting Temperature and Freezing Temperature,
and Change in Temperature Loop (ΔTₗₒₒₚ) for Comparative
Example 1 and Examples 1-5

| Example | Qₘₑₗₜ (J/g) | Q_{freeze} (J/g) | Tₘₑₗₜ − T_{freeze} (° C.) | ΔTₗₒₒₚ (° C.) |
|---|---|---|---|---|
| C4 | −94.8 | 68.4 | 14.50 | 5.68 |
| 1 | −89.4 | 58.5 | 14.99 | 5.82 |
| 2 | −85.5 | 65.7 | 12.49 | 5.05 |
| 3 | −177.3 | 88.8 | 12.82 | 2.26 |
| 4 | −109.8 | 92.1 | 13.44 | 4.01 |
| 5 | −120.9 | 93.9 | 11.14 | 0.62 |

Via a comparison of Comparative Examples 1 to 3 it was revealed that Comparative Example 1 demonstrated multiple exothermic peaks (i.e., phase transitions), suggesting that the freezing of the comparative composition is not uniform and there is a large supercooling effect (ΔT>34° C.). The number of exothermic peaks decrease with the addition of Borax, along with the energy released, confirming the activity of Borax as a nucleating agent. The exothermic loops are due to the supercooling of the comparative compositions and are associated with nucleation kinetics and total heat released. The heat release causes the sample to warm up faster than the experimental control. The temperature range over which the exothermic loops are distributed is represented by ΔTₗₒₒₚ. As represented in Table 4, the specific heat of melting (Qₘₑₗₜ) did not considerably change with the addition of increasing amounts of Borax, although the specific heat of freezing (Q_{freeze}) increased with respect to the amount of Borax. The ΔTₗₒₒₚ (temperature width of the exothermic loop), first decreased from 1.51 to 0.51° C. with an increase in 50 mg of Borax, but then increased to 5.01° C. for a Borax content of 101 mg. Increasing the Borax concentration above 1 mass % effectively shifted the nucleation loop to higher temperatures, thereby reducing supercooling and improving nucleation kinetics.

Comparative Example 4 and Examples 1 to 5 demonstrated two large exothermic loops as opposed to the Comparative Examples 1 to 3 which show only one primary exothermic loop. The presence of two large exothermic loops indicates that there are two distinct structural changes that are reversible. The reversibility indicates that the presence of two large exothermic loops is likely the result of locking of different crystalline hydrated structures. As shown in Table 5, generally, the temperature difference between the point of melting and the point of cooling and the ΔTₗₒₒₚ decreased with respect to the thiosulfate content. The magnitude of the Qₘₑₗₜ and Q_{freeze} both displayed an increasing trend with respect to the thiosulfate content, suggesting that adding more thiosulfate results in a greater energy release during phase transformation. Furthermore, for Example 5, the width of the exothermic loop was significantly smaller as compared to the other samples. This smaller loop, when combined with the relatively greater IQ values, suggests that the energy release in Example 5 was more uniform as compared to Comparative Example 4 and Examples 1 to 4. These results indicate that the inclusion of thiosulfate salt hydrate decreases the degree of supercooling and increases the exotherm during crystallization, thereby reducing the barrier height for nucleation and subsequent crystallization of the PCM.

The conductivity of all exemplary compositions increases with temperature with drastic changes associated with the solid-liquid phase changes. Ionic transport is more restricted in the solid state than in the liquid state. In the liquid state, the conductivity values did not markedly change with the cycling for any Example. However, in the solid state, the low temperature conductivity values exhibiting an increased trend over time, except for Comparative Example 3. Given that Comparative Example 3 also showed improved cyclability (i.e., the lowest supercooling and greatest Q_{freeze}) it is likely that the addition of Borax stabilized the solid electrolyte phase to exhibit reproducibility. Additionally, the resulting structure of the solid phase shows greater ionic conductivity.

Throughout the Examples, phase transitions result in orders of magnitude changes in conductivity. The conductivity of the exemplary PCMs in the liquid state are not significantly affected by formulation. In contrast, minimum conductivity values increase with cycling and with thiosulfate salt hydrate content, suggesting that the thiosulfate salt hydrate containing PCMs require extended thermal cycling to stabilize performance. Examples 4 and 5 show the least change in low temperature conductivity; however, Examples 4 and 5 still show a doubling in conductivity with thermal cycling. The maximum conductivity in the solid phase increased with the thiosulfate salt hydrate content until the maximum was found in Example 4.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. As used herein, the term “about” indicates values within the range of ±25%, alternatively ±10%, alternatively ±5%, alternatively ±1% of the modified value.

1. A phase change material composition for combined electrochemical and thermal energy storage, the composition comprising:
a salt hydrate in an amount of from 0.1 to 80 wt. %;
a polymeric stabilizer in an amount of from 0.1 to 20 wt. %;
a non-electrical conducting nucleating agent in an amount of from 0.1 to 20 wt. %; and
a thiosulfate salt hydrate in an amount of from 0.1 to 25 wt. %;
wherein each wt. % is based on 100 total parts by weight of the composition.

2. The composition of claim 1, wherein the salt hydrate comprises a cation comprising hydrogen, lithium, sodium, potassium, cesium, ammonium, tetraethylammonium or a combination thereof.

3. The composition of claim 1, wherein the salt hydrate comprises an anion comprising sulfate, thiosulfate, carbonate, bicarbonate, chloride, fluoride, borate, acetate, acetoacetate, oxalate, formate, phosphate, dihydrogen phosphate, and/or hydrogen phosphate.

4. The composition of claim 1, wherein the salt hydrate comprises a sodium sulfate decahydrate.

5. The composition of claim 4, wherein the salt hydrate comprises sodium hydrogen phosphate.

6. The composition of claim 5, wherein the salt hydrate comprises the sodium sulfate decahydrate and the sodium hydrogen phosphate in a mass ratio of 1:100 to 1:2.

7. The composition of claim 5, wherein the salt hydrate comprises the sodium sulfate decahydrate and the sodium hydrogen phosphate in a mass ratio of 1:8 to 1:3.

8. The composition of claim 5, wherein the salt hydrate comprises the sodium sulfate decahydrate and the sodium hydrogen phosphate in a mass ratio of 1:4.5 to 1:3.5.

9. The composition of claim 1, wherein the polymeric stabilizer comprises a polysaccharide selected from the group of a nanocellulose, a sulfonated polysaccharide, a starch, a glycogen, a chitin, and combinations thereof.

10. The composition of claim 1, wherein the polymeric stabilizer comprises sodium alginate, lithium alginate, potassium alginate, ammonium alginate, or a combination thereof.

11. The composition of claim 1, wherein the nucleating agent comprises an electrical insulating inorganic salt.

12. The composition of claim 11, wherein the electrical insulating inorganic salt comprises CaF₂, sodium borate, sodium thiosulphate, sodium hydrogen phosphate, TiO₂, Al₂O₃, ZrO₂, Y₂O₃, HfO₂, GeO₂, Sc₂O₃, CeO₂, MgO, BN, SiO₂, or combinations thereof.

13. The composition of claim 1, wherein the thiosulfate salt hydrate comprises sodium thiosulfate pentahydrate.

14. The composition of claim 1, wherein
the salt hydrate is present in an amount of from 80 to 97 wt. %;
the polymeric stabilizer is present in an amount of from 1 to 10 wt. %;
the nucleating agent is present in an amount of from 0.3 to 3 wt. %;
the thiosulfate salt hydrate is present in an amount of from 0.2 to 20 wt. %; and
wherein each wt. % is based on 100 total parts by weight of the composition.

15. The composition of claim 14, wherein
the salt hydrate is present in an amount of from 90 to 97 wt. %;
the polymeric stabilizer is present in an amount of from 2 to 7 wt. %;
the nucleating agent is present in an amount of from 2 to 3 wt. %;
the thiosulfate salt hydrate is present in an amount of from 7.5 to 17.5 wt. %;
wherein each wt. % is based on 100 total parts by weight of the composition.

16. The composition of claim 1, wherein the composition has an overall ionic conductivity of between 1.0 S/cm and 1.0 mS/cm in a liquid state.

17. The composition of claim 1, wherein the composition has an overall ionic conductivity of between 10.0 mS/cm and 0.01 mS/cm in a solid state.

18. The composition of claim 1, wherein the composition is disposed within an electrochemical battery.

19. A combined electrochemical and thermal storage system comprising the phase change material composition of claim 1.

20. An assembly comprising:
a separator having a separator surface and defining pores; and
a phase change material disposed within the pores and comprising:
a salt or salt mixture in an amount of from 0.1 to 80 wt. %;
a polymeric stabilizer in an amount of from 0.1 to 20 wt. %;
a non-electrical conducting nucleating agent in an amount of from 0.1 to 20 wt. %; and
a polar protic solvent in the amount of from 10 to 80 wt. %;
wherein each wt. % is based on 100 total parts by weight of the composition; and
wherein the separator has a porosity between 20 and 80% by volume of the separator.
